(19) United States
(12) Patent Application Publication
(10) Pub. No.: US 2026/0120987 A1
(43) Pub. Date: Apr. 30, 2026

(54) HIGH VOLTAGE CIRCUIT-BREAKER

(71) Applicant: Hitachi Energy Ltd, Zürich (CH)

(72) Inventors: Christoph Wirth, Pfungen (CH); Mahesh Dhotre, Brugg (CH); Valeria Teppati, Otelfingen (CH); Brian Christopher, Smithfield, PA (US); Matt Cuppett, Uniontown, PA (US); Christian Daehler, Greensburg, PA (US)

(21) Appl. No.: 19/470,281

(22) PCT Filed: Mar. 30, 2023
(86) PCT No.: PCT/EP2023/058355

§ 371 Date: Sep. 29, 2025

(51) Int. Cl. H01H 33/91; H01H 1/38; H01H 1/66; H01H 33/56; H01H 33/88

(52) U.S. Cl. CPC H01H 33/91; H01H 1/385; H01H 1/66; H01H 33/565; H01H 2033/888

(57) ABSTRACT

The disclosed circuit-breaker for high-voltage applications includes at least one making and breaking unit having a first contact and a second contact for forming an electrically conductive connection, wherein at least one of the contacts is movable along an axially extending switching axis of the circuit-breaker between a closed position and an open position, and a first contact housing having a guiding passage surrounding and forming with the first contact a circumferential gap, which first contact housing has at least one recess surrounding the first contact, which at least one recess is open towards the first contact by means of a recess opening facing the first contact, wherein an extension of the recess opening along the switching axis is shorter than an extension of the at least one recess along the switching axis and/or two or more the recesses are arranged axially adjacent to one another.

### CROSS REFERENCE TO RELATED APPLICATIONS

This application is a 35 U.S.C. § 371 national stage application of PCT International Application No. PCT/EP2023/058355 filed on Mar. 30, 2023, the disclosure and content of which is incorporated by reference herein in its entirety.

### TECHNICAL FIELD

The present disclosure relates to a circuit-breaker for high-voltage applications comprising at least one making and breaking unit having two contacts for forming an electrically conductive connection in a connection region, wherein at least one of the contacts is movable between a closed position where the electrically conductive connection is formed and an open position where the electrically conductive connection is separated, and comprising a first contact housing having a guiding passage surrounding and forming with the first contact a circumferential gap.

### BACKGROUND

In high voltage circuit-breakers, where two contacts typically can be moved relative to each other while being arranged electrically substantially isolatedly relative to the surrounding and being subject to insulating gas, particles and hot gas need to be avoided at the location of any dielectrically critical regions. Such dielectrically critical regions may occur anywhere at or in the circuit-breaker where conducting like parts of the contacts parts are present. Particularly in the vicinity of the circumferential gap particles may be generated or may occur which may cause adverse electrical effects.

### SUMMARY

The present disclosure aims at avoiding a build-up of particles in the region of the circumferential gap and at providing a more reliable and/or a longer-to-use circuit-breaker.

It is therefore an object of the present disclosure to provide a circuit-breaker having improved ability to economically interrupt high-voltage connections. Particularly it is an object to provide a circuit-breaker having an ability to better deal with insulating gas carrying particles along the first contact and/or through the circumferential gap. Particularly it is an object to avoid or reduce disadvantages of known circuit-breakers.

The object of the present disclosure is solved by the features of the independent claims. Example implementations are detailed in the dependent claims.

Thus, the object is solved by a circuit-breaker for high-voltage applications comprising
at least one making and breaking unit having a first contact and a second contact for forming an electrically conductive connection in a connection region, wherein at least one of the contacts is movable along an axially extending switching axis of the circuit-breaker between a closed position where the electrically conductive connection is formed and an open position where the electrically conductive connection is separated; and
a first contact housing having a guiding passage surrounding and forming with the first contact, particularly a first contact section, a circumferential gap, which first contact housing has at least one recess surrounding the first contact, particularly the first contact section, which at least one recess is open towards the first contact, particularly the first contact section, by means of a recess opening facing the first contact, particularly the first contact section, for trapping particles carried by an insulating gas coming from the connection region and passing the circumferential gap; wherein
an extension of the recess opening in particular along the switching axis is shorter than an extension of the at least one recess in particular along the switching axis and/or two or more of said at least one recesses are arranged axially adjacent to one another.

The proposed solution is based on the idea that two contacts, where one or both of the contacts are movable relative to each other along at least one axial direction in order to have an electrical connection that can be separated, carrying a high voltage may be held to be separated within an insulating gas supporting arc extinguishment. Since the presence of particles and hot insulating gas needs to be avoided at dielectrically critical regions, the present disclosure aims at a better sealing function for such hot or heated insulating gas and particles carried thereby by means of implementing geometric features in the vicinity of the first contact which may provide flow turbulences capable of trapping particles and lowering the gas temperature due to gas expansion. It is a further idea to reduce the generation of particles at the first contact and/or in the circumferential gap surrounding the first contact, e.g., where the first contact is sealed.

Particularly, the present disclosure provides by means of the circumferential gap a particularly contactless sealing particularly to substantially and/or partially hold back the insulating gas likely carrying particles. The at least one recess is able to trap at least some of the particles carried by means of the insulating gas passing the recess. There may be the recess opening provided for the insulating gas to enter and mix with the insulating gas inside the at least one recess. Particles may be collected and/or settle down by means of gravity in the lowermost point of the at least one recess. A flow of insulating gas can be effectively slowed down and/or mixed with cold and/or standing insulating gas in the at least one recess, particularly due to an increase of the sectional area the insulating gas coming through the guiding passage and/or the circumferential gap is facing. This helps to eject particles carried by the insulating gas into the at least one recess.

In other words the idea is to have a turbulence creator within the guiding passage facing the first contact and/or being located, particular in at least one position and/or the open position, proximal to the circumferential gap. Providing a plurality of the at least one recess and/or a constricted gap via the recess opening is key to trapping particles when insulating gas carrying such particles passes the circumferential gap. Typically, there in the at least one recess gas is slowed down and/or mix with cold insulating gas and particles may fall out. By means of the present disclosure the number of allowable cycles of the circuit-breaker can be increased and the reliability can be increased. Particularly, the voltage to be interrupted can be increased.

The present disclosure provides a better sealing function for especially heated insulating gas by providing a trap mechanism for particles which may pass along the first contact.

By means of the disclosed subject matter and by means of aspects described in the present application, at least one buffer volume structure is implemented which leads to flow turbulences capable of trapping particles and lowering the gas temperature due to gas expansion. Since a solid sealing system will lead always to ablation and therefore to generation of particles, the present disclosure avoids or reduces adverse effects of particles carried by insulating gas.

Particles as mentioned in the present application may be generated from friction between the contacts, from friction from guiding any parts of the circuit-breaker mechanically, and/or from grease, residue, deterioration/aging of parts, dust or the like. Particles may be carried by means of the insulating gas since the insulating gas is typically moved-passively or actively-when the contacts are separated. Particles may compromise dielectric strength where they are present.

In the closed position the contacts touch each other in order to provide an electrical connection. In the open position the contacts are separated from each other and/or are arranged axially distant to each other in order to provide a separation of the electrical connection. When the contacts are being disconnected/separated and/or being moved away from each other, an electrical arc may form in the connection region that temporarily generates an extensive amount of heat, e.g., heating the insulating gas, and/or may generate particles from evaporating material, e.g., of at least one of the contacts, which material may resolidify in the form of particles.

Typically both contacts are at least partially designed from a material that can conduct electricity, particularly metal. At least one of the contacts, particularly the first contact, may be at least partially designed to be electrically conductive. Said contact is not required to be electrically conductive in its entirety. Some parts or sections of said contact, e.g., a pull rod, may be electrically insulating, e.g., made from ceramics, plastics or other electrically non-conducting material. Said contact is particularly characterized by being movable at least in part or in its entirety, particularly relative to the first contact housing, relative to another housing of the circuit-breaker, relative to the other contact and/or relative to its surrounding. Said contact may at least partially comprise or consist of copper, gold and/or tungsten and/or is coated therewith.

At least one contact being movable is generally understood in that a relative movement relative to another part can be achieved. For example, the first contact is understood to be movable when the first contact housing is moved relative to the first contact, where the first contact could be at least substantially fixed in the circuit-breaker.

The first contact housing may be designed to guide the first contact, particularly a first contact section. The first contact housing may be held movable relative to the first contact, particularly along the switching axis. The first contact may be guided in the first contact housing following the guiding passage, particularly centrically. Thereby the first contact may or may not touch the guiding passage. In any case, the first contact and/or its first contact section forms a circumferential gap in the guiding passage that particularly extends axially and/or has a radial extension at least half as large as the diameter of the guiding passage and/or at least one or two order(s) of magnitude smaller than the diameter of the guiding passage. Either the first contact housing, or the first contact or both, may be movable along the switching axis relative to their surrounding, e.g., another housing. Also the second contact may be movable along the switching axis relative to its surrounding, e.g., another housing.

Typically, the circumferential gap is formed where the first contact and the first contact housing are movable relative to one another and where insulating gas may pass due to a physical path being present. The circumferential gap may form at an axially local radial constriction between the first contact (section) and the first contact housing which may even move as a function of the position of the first contact and its housing relative to each other.

It can be an option that the first contact housing is arranged movably at the first contact to compress by means of a cylinder and a piston insulating gas that is pushed towards the connection region upon a separation movement of the circuit-breaker, e.g., in order to support arc extinguishment. The compressed gas, particularly in a heated state, may at least partially pass the circumferential gap where a beneficial use of the at least one recess is applied. The first contact, particularly the first contact section, and the first contact housing may be in contact to each other.

It can be an option that the first contact is arranged particularly movably within the first contact housing in the guiding passage wherein the circumferential gap is formed particularly without in mechanical contact, for example, in at least in an/the open position. Particularly a plurality of the at least one recess is beneficial in this case, for example a number of three, four, five or more recesses, for example arranged axially adjacent to one another, e.g., over an axial length of at least 5 mm and/or of up to 500 mm or up to 200 mm. In a very basic and effective design the at least one recess is in the shape of a particularly annular groove, typically radially deeper than its axial wideness. The first contact may have a hollow shape particularly to decrease inertia.

The circumferential gap particularly follows the position of the first contact in the guiding passage. As such, the circumferential gap may be movable relative to the at least one recess. The circumferential gap may particularly be understood to comprise a radial extension that is at least by the factor of two or more, particularly one or two order(s) of magnitude or more, smaller than its axial extension. In other words, the circumferential gap may be radially flat and/or axially elongated.

The first contact section may have an at least substantially cylindrical shape and/or outer surface. The guiding passage may have an at least substantially cylindrical shape, inner surface and/or inner wall. The first contact section and the guiding passage may correspond to each other in order to form an at least substantially annular and/or circumferential free space, particularly the circumferential gap. A diameter of the first contact section, particularly the outer surface, may be at least 0.1 % and/or up to 10 % or up to 5 % smaller than a diameter of the guiding passage, particularly the inner surface, in order to form the circumferential gap. The first contact section can have an particularly annular guiding and/or sealing means to guide and/or seal at the guiding passage, particularly at the inner wall.

The at least one recess can be in direct fluid contact with the circumferential gap in at least in one position of the first contact, particularly an/the open position. The at least one recess is particularly located to be in the axial vicinity of the circumferential gap.

The at least one recess can be covered and/or closed by means of the circumferential gap and/or the first contact, particularly a first contact section, in at least one position of the first contact e.g., in order to avoid or to substantially reduce particularly hot insulating gas to enter the at least one recess. The length of the first contact forming the circumferential gap, particularly the first contact section, e.g., in the form of a piston, a plunger and/or a sleeve and/or having the outer surface, is designed in a way that in at least one position, for example, at contact separation and/or in the open position and/or when a distance is created upon contact separation between the contacts, it closes/covers the at least one recess, for example, with an axial overlap on both axial sides of the at least one recess. In some embodiments, the axial overlap on one or both axial sides may be selected to be at least 1 mm, 2 mm, 3 mm, 4 mm, 5 mm or more.

During an opening operation of the circuit-breaker, the at least one recess may be closed/covered at least at a certain position, typically at the start of physical contact separation. This makes the at least one recess to be a substantially closed volume where the only opening or path towards is the circumferential gap or annular gap between the first contact and an inner wall of the guiding passage. Particularly hot insulating gas then may enter the at least one recess in a closed/covered state, and typically only later also reaches an exhaust and/or the full volume inside a support insulator carrying the circuit-breaker. As a result, the support insulator is at least partially or substantially sealed with respect to insulating gas and particles carried thereby when the circuit-breaker is being opened.

The at least one recess is according to an idea of the present disclosure provided in a plurality and/or the recess opening is provided which is constricted relative to the at least one recess in an axial direction. This helps to provide a turbulence and/or a change of speed and/or direction to the insulating gas passing the at least one recess in order to have particles trapped. The particles may be thrown out to the at least one recess from the flow of insulating gas from centrifugal force and/or from a spontaneous change in speed in the at least one recess.

A damping means may be provided to dampen the movement, particularly of at least one of the contacts and/or the first contact housing and/or another housing, particularly of the first contact, particularly which is built to provide a damping force acting and/or increasing along the switching axis, especially as a function of moving distance, stroke, acceleration, speed, jerk and/or similar of the first contact.

The term high voltage relates to voltages that exceeds 1 kV. A high voltage may concern nominal voltages in the range from above 72 kV to 800 kV, like 145 kV, 245 kV or 420 kV. The (high voltage) circuit-breaker may be provided as a circuit breaker and/or may include one or more components such as, a puffer-type cylinder, a self-blast chamber, a pressure collecting space, a compression space, or puffer volume, and an expansion space. The high voltage circuit-breaker may effectuate interruption of the conductive connections by means of one or more of such components, thereby discontinuing flow of electrical current in the conductive connections, and/or extinction of the arc produced when the conductive connections is interrupted. The term “axial” designates an extension, distance etc. in the direction of the axis and/or switching axis. An axial separation between parts means that these parts are separated from each other when seen or measured in the direction of the axis. The term “radial” designates an extension, distance etc. in a direction perpendicular to the axis. The term “cross-section” means a plane perpendicular to the axis, and the term “cross-sectional area” means an area in such a plane. The “axis” the term “axially extending” and the like typically relate to the switching axis.

The insulating gas and/or dielectric insulation medium can be any suitable gas that enables to adequately extinguish the electric arc formed between the contact elements during a current interruption operation, such as, but not limited, to an inert gas as, for example, sulphur hexafluoride SF6. Specifically, the insulating gas used can be SF6 gas or any other dielectric insulation medium and/or insulating gas, may it be gaseous and/or liquid, and in particular can be a dielectric insulation gas or arc quenching gas. Such dielectric insulation medium and/or insulating gas can for example encompass media comprising an organofluorine compound, such organofluorine compound being selected from the group consisting of: a fluoroether, an oxirane, a fluoroamine, a fluoroketone, a fluoroolefin, a fluoronitrile, and mixtures and/or decomposition products thereof. Herein, the terms “fluoroether”, “oxirane”, “fluoroamine”, “fluoroketone”, “fluoroolefin” and “fluoronitrile” refer to at least partially fluorinated compounds. In particular, the term “fluoroether” encompasses both hydrofluoroethers and perfluoroethers, the term “oxirane” encompasses both hydrofluorooxiranes and perfluorooxiranes, the term “fluoroamine” encompasses both hydrofluoroamines and perfluoroamines, the term “fluoroketone” encompasses both hydrofluoroketones and perfluoroketones, the term “fluoroolefin” encompasses both hydrofluoroolefins and perfluoroolefins, and the term “fluoronitrile” encompasses both hydrofluoronitriles and perfluoronitriles. In some embodiments, the fluoroether, the oxirane, the fluoroamine and the fluoroketone are fully fluorinated, i.e., perfluorinated.

The insulating gas and/or dielectric insulation medium can be selected from the group consisting of: a hydrofluoroether, a perfluoroketone, a hydrofluoroolefin, a perfluoronitrile, and mixtures thereof. In particular, the term “fluoroketone” as used in the context of the present disclosure shall be interpreted broadly and shall encompass both fluoromonoketones and fluorodiketones or generally fluoropolyketones. Explicitly, more than a single carbonyl group flanked by carbon atoms may be present in the molecule. The term shall also encompass both saturated compounds and unsaturated compounds including double and/or triple bonds between carbon atoms. The at least partially fluorinated alkyl chain of the fluoroketones can be linear or branched and can optionally form a ring. The dielectric insulation medium and/or insulating gas may comprise at least one compound being a fluoromonoketone and/or comprising also heteroatoms incorporated into the carbon backbone of the molecules, such as at least one of: a nitrogen atom, oxygen atom and sulphur atom, replacing one or more carbon atoms. In some embodiments, the fluoromonoketone, in particular perfluoroketone, can have from 3 to 15 or from 4 to 12 carbon atoms and particularly from 5 to 9 carbon atoms. In some embodiments, it may comprise exactly 5 carbon atoms and/or exactly 6 carbon atoms and/or exactly 7 carbon atoms and/or exactly 8 carbon atoms.

Further, the insulating gas and/or dielectric insulation medium may comprise at least one compound being a fluoroolefin selected from the group consisting of: hydrofluoroolefins (HFO) comprising at least three carbon atoms, hydrofluoroolefins (HFO) comprising exactly three carbon atoms, trans-1,3,3,3-tetrafluoro-1-propene (HFO-1234ze), 2,3,3,3-tetrafluoro-1-propene (HFO-1234yf), and mixtures thereof. The organofluorine compound can also be a fluoronitrile, in particular a perfluoronitrile. In particular, the organofluorine compound can be a fluoronitrile, specifically a perfluoronitrile, containing two carbon atoms, and/or three carbon atoms, and/or four carbon atoms. More particularly, the fluoronitrile can be a perfluoroalkylnitrile, specifically perfluoroacetonitrile, perfluoropropionitrile (C2F5CN) and/or perfluoro-butyronitrile (C3F7CN). Most particularly, the fluoronitrile can be perfluoroisobutyronitrile (according to the formula (CF3)2CFCN) and/or perfluoro-2-methoxypropanenitrile (according to formula CF3CF(OCF3)CN). Of these, perfluoroisobutyronitrile (i.e., 2,3,3,3-tetrafluoro-2-trifluoromethyl propanenitrile alias i-C3F7CN) is particularly preferred due to its low toxicity. The dielectric insulation medium and/or insulating gas can further comprise a background gas or carrier gas different from the organofluorine compound (in particular different from the fluoroether, the oxirane, the fluoroamine, the fluoroketone and the fluoroolefin) and can in embodiments be selected from the group consisting of: air, N2, O2, CO2, a noble gas, H2; NO2, NO, N2O; fluorocarbons and in particular perfluorocarbons, such as CF4; CF31, SF6; and mixtures thereof. For example, the dielectric insulating gas can be CO2 in an embodiment.

In another implementation the circumferential gap forms a particularly direct or indirect passage for the insulating gas between the connection region and an exhaust of the circuit-breaker. The circumferential gap may be a side passage for insulating gas that leaks from a primary passage. The circumferential gap may form a passage along the first contact and/or towards a drive device of the circuit-breaker. The circumferential gap may at least substantially comprise a cylindrical shape.

In another implementation the circuit-breaker has a gas moving device that is particularly built to move the insulating gas at least at the connection region and towards the circumferential gap. In other words the gas moving device may be a mechanism to push and/or compress the insulating gas. The gas moving device may be fluidly coupled to the connection region, particularly at least indirectly or directly.

The gas moving device may comprise a cylinder with a piston movable therein along the switching axis, particularly which piston is motion-coupled to the first contact housing and/or to the first contact in order to vary a cylinder volume as a function of the position of the piston in the cylinder. It may be that the first contact is movable relative to the first contact housing or vice versa.

In another implementation the first contact and the first contact housing are movable relative to one another and/or along the switching axis. The first contact may be movable relative to the first contact housing (or vice versa) in order to particularly in the open position radially substantially—i.e., in particular not by 100 %—close and/or cover the recess opening and/or to particularly in the open position form the circumferential gap on both sides axially adjacent to the recess opening. In other words the first contact may have means that can at least substantially block the fluid access to the recess, wherein the blocking may occur as a function of the axial position of the first contact. Particularly when the contacts are separated the recess opening may be at least substantially closed/covered/blocked, for example between the (fully) open position and the closed position. This has been proven to be beneficial to particle trapping.

In another implementation the recess opening and/or the at least one recess at least substantially has/have an annular shape. In other words the at least one recess and/or the recess opening (or a plurality thereof) may partially, sectionally and/or fully have a ring shape and/or surround the first contact. This provides a substantially circumferentially homogeneous flow path for the insulating gas so that particles can be trapped reliably at the most of the circumferential locations.

In another implementation the recess opening has an axially extending protrusion in order to constrict the access to the at least one recess. In some embodiments, the recess opening is particularly axially constricted relative to the at least one recess. This provides that hot insulating gas passing the recess opening can mix with a substantial volume of cold insulating gas in the at least one recess while a tight and substantially large circumferential gap is maintained. The protrusion may comprise an at least substantially and/or sectionally annular shape.

It may be provided that the recess opening is the only opening to the at least one recess. In other words the at least one recess may be accessible only via the recess opening and/or only via the inside of the guiding passage. There may be more than one recess opening. As such the at least one recess may be able to reliably collect particles substantially without the risk of loss of particles to further regions away from the connection region.

In another implementation the axially extending protrusion is formed to at least partially shape the guiding passage. The protrusion may have a cylindrical and/or annular shape, at least at the side facing away from the at least one recess and/or facing the first contact. The protrusion may be formed monolithically within the guiding passage. The protrusion may partake in forming the guiding passage and/or the circumferential gap, at least in the open position and/or in at least one position of the first contact. Via the protrusion the at least one recess may comprise a radial undercut, particularly to trap particle. At its free end the protrusion may be sharpened and/or tapered, particularly wherein an angled surface of the protrusion may face towards the at least one recess. The protrusion may run at least substantially in parallel to the switching axis.

In another implementation the axially extending protrusion faces and/or points towards the connection region. The protrusion is particularly located so that the at least one recess partially extends along the switching axis separately from the guiding passage and/or in a direction away from the connection region. The particle entrapment has been proven to be enhanced in such an arrangement, particularly since aerodynamically dead zones may be created.

In another implementation the first contact is in contact to an inner wall of guiding passage to guide the first contact and/or to substantially seal the circumferential gap to the insulating gas. The first contact may be equipped with a particularly annular sealing and/or a particularly annular guiding material that runs along the inner wall when the circuit-breaker is operated. Despite bring in contact to and/or despite the sealing, no solution may provide a perfect fluid tightness without a transportation of particles in the insulating gas. However, this may support that less particles end up in the at least one recess.

In another implementation the first contact is guided. The first contact particularly is guided along the switching axis. The first contact particularly is at least substantially movable only along the switching axis at least when in the closed position, in the open position and/or in between the closed position and the open position. This ensures a constant circumferential gap size and a reliable access to the at least one recess in order to entrap particles.

In another implementation the extension of the at least one recess along the switching axis is larger than the extension of the at least one recess oblique to the switching axis. The at least one recess may particularly be of a radially flat and/or axially elongated shape in a section in parallel to the switching axis.

In another implementation the extension of the at least one recess along the switching axis is smaller than an extension of the at least one recess oblique to the switching axis. The at least one recess may particularly be of a radially elongated and/or axially flat shape in a section in parallel to the switching axis.

In another implementation three or more of the at least one recesses are arranged axially adjacent to one another. It has been proven that a plurality of the at least one recess is beneficial to particle entrapment. For example, the at least one recesses may be separated by means of a radial protrusion, particularly a single radial protrusion, particularly the protrusion to face and/or form the guiding passage, e.g., by means of its free end and/or its radially inside facing surface.

In another implementation the first contact is hollow and/or has at least one opening for the insulating gas. The first contact may be designed to guide at least sectionally the insulating gas. The second contact may be designed to be plugged into the first contact. The second contact may be in the shape of a pin to be plugged into the first contact particularly when in the closed position. The second contact may be plugged into the first contact, e.g., the channel thereof. Thereby the circuit-breaker can be designed in a more compact manner.

In another implementation the insulating gas is contained in an at least substantially fluidly tight volume of the circuit-breaker. The amount of insulating gas may be at least substantially predetermined. Said volume may be at least substantially pressure tight. Accordingly a loss of insulating gas may be prevented and the ability to reuse the circuit-breaker at little to no maintenance is provided.

The circuit-breaker may have a/the drive device or drive particularly motion-coupled to the first contact and configured for moving the first contact. The drive device may be arranged at one end of the making and breaking unit and/or distant to the connection region and/or the second contact for a compact arrangement. The drive device may be configured to switch between at least two of the positions named herein. The drive device may be motorized and/or provided outside of the housing. In such implementation the drive device can be connected to the first contact element via a pull rod. The drive device may comprise an additional damper, which can be associated and/or integrated to the drive device.

Further implementations and advantages of the method are directly and unambiguously derived by the person skilled in the art from the high voltage circuit-breaker as described before.

### BRIEF DESCRIPTION OF DRAWINGS

These and other aspects of the present disclosure will be apparent from and elucidated with reference to the implementations described hereinafter.

In the drawings:

FIG. 1A-D shows a high voltage circuit-breaker according to an implementation in a cross-sectional schematic view and in different positions,

FIG. 2A-B shows a high voltage circuit-breaker according to another implementation in a cross-sectional schematic view and in different positions, and

FIG. 3 shows the high voltage circuit-breaker of FIG. 2B in a detailed view.

### DETAILED DESCRIPTION

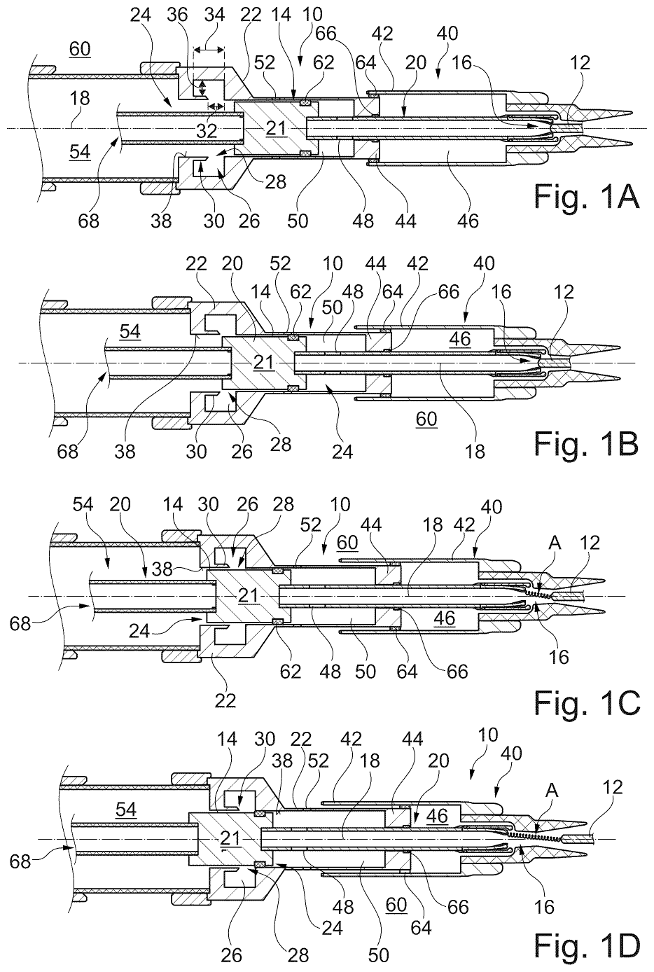

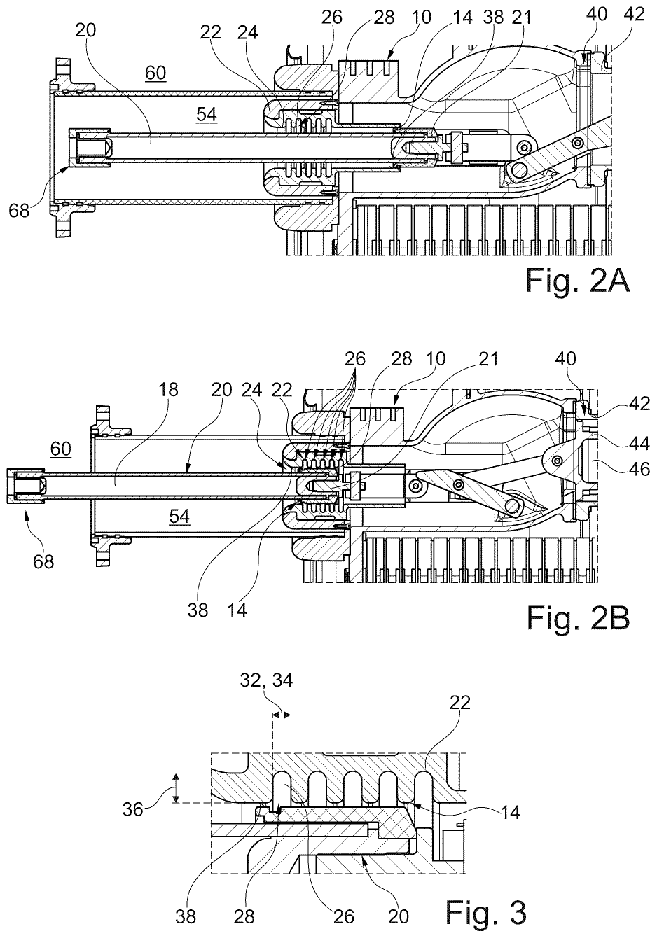

The description of FIG. 1A-D and FIG. 2-3 contains procedural or methodic aspects upon describing structural features of the circuit-breakers; the structural features can be understood well in that way. It is emphasized to the reader that such structural features can be lifted from the described context without hesitation or the question of an intermediate generalization to form aspects of the present disclosure. An example for this may be found in openings 48 or 52. It is also emphasized to the reader that any the structural features described in the following can be understood as individual aspects of the present disclosure to distinguish from known solutions, despite being possibly lifted from the context.

FIG. 1A-D discloses a circuit-breaker for high-voltage applications comprising a making and breaking unit 10 that has a first contact 20 and a second contact 12 for forming an electrically conductive connection in a connection region 16. The first contact 20 is at least partially hollow and the second contact 12 is a pin to be plugged into the first contact 20 when in the closed position as shown in FIG. 1D. At one end 68 of the first contact 20 particularly opposite the contact region 16 a pull rod and/or a drive device may be placed. The circuit-breaker is in a volume 60 of insulating gas an furthermore contains insulating gas.

Here, the first contact 20 is made from separate parts connected to each other. Particularly, the first contact 20 has a first contact section 21 of a cylindrical shape and a hollow or tube like electrically conductive tip facing the connection region 16. At the end 68, the electrically insulating and hollow pull rod is connected to the first contact section 21.

The first contact section 21 may comprise an at least partially hollow shape (not shown). However, the first contact section 21 may at least substantially serve as a plunger in the first contact housing 22 to form the circumferential gap 14 as the primary path for insulating gas to flow through in the guiding passage 24.

Both contacts 12, 20 are movable along an axially extending switching axis 18 between a closed position (as shown in FIG. 1A) where the electrically conductive connection is formed and an open position where the electrically conductive connection is separated (FIGS. 1C and 1D). Here, predominantly the second contact 12 is movable, while a first contact housing 22 is also movable.

The first contact housing 22 having a guiding passage 24 is provided that surrounds and forms with the first contact 20 a circumferential gap 14. The first contact housing 22 is axially movable particularly relative to the first contact 20 in order to enable a movement of insulating gas in the connection region 16.

The first contact housing 22 has one annular shaped recess 26 particularly forming a recessed volume surrounding the first contact 20 at its first contact section 21. The first contact section 21 has a cylindrical outer surface that corresponds to a cylindrical inner surface, particularly an inner wall 38, of the guiding passage. Between said surfaces the circumferential gap 14 forms.

The recess 26 is open towards the first contact 20 by means of a an annular shaped recess opening 28 facing the first contact 20 and—as a function of the position—facing the circumferential gap 14 for trapping particles carried by an insulating gas coming from the connection region 16 and passing the circumferential gap 14. In FIG. 1B-1D the circumferential gap 14 is arranged adjacent to and/or covers the recess opening 28. In FIG. 1A however the circumferential gap 14 is arranged in the axial vicinity of the recess opening 28, e.g., at a distance.

An extension 32 of the recess opening 28 along the switching axis 18 is shorter than an extension 34 of the at least one recess 26 along the switching axis 22.

The circumferential gap 14 forms a passage for the insulating gas between the connection region 16 and an exhaust 54 of the circuit-breaker.

A gas moving device 40, e.g., a compressor, is provided that is built to move the insulating gas via the connection region 16, particularly towards the circumferential gap 14. The device 40 has a cylinder 42 with a piston 44, which piston 44 is movable in the cylinder 42 and is motion-coupled to the first contact housing 22. The piston 44 is sealed by means of annular guiding and/or sealing means 64, 66 radially inside relative to the first contact 20 and radially outside relative to the cylinder 42.

The cylinder volume 46 can be varied as a function of the position of the first contact housing 22, wherein by reducing the volume 46 insulating gas can be compressed and moved. As shown in the transitions between FIG. 1A to FIG. 1D the first contact housing 22 is moved to reduce the volume 46, whereby the first contact section 21 gradually covers the recess opening 28. When the contacts 12, 20 are being separated and forming an arc A as in FIG. 1C, the recess opening 28 is covered on both axial sides.

During the opening of the circuit-breaker as shown over the course of FIGS. 1A-D, the insulating gas travels via the connection region 16 through the hollow first contact 12 at its electrically conductive tip. The insulating gas may come out at radial openings 48 of the first contact 12 arranged distant to the connection region 16 to enter a chamber 50 between the first contact 20 and the first contact housing 22. Said chamber 50 may be built to increase in volume upon a separation movement of the circuit-breaker as shown. Openings 52 of the first contact housing 22 initially covered by means of the first contact section 21 become uncovered upon reaching the position of FIG. 1C. The first contact 20 substantially stands still, while the second contact 12 is axially pulled out of the first contact 20 and while the first contact housing 22 is moved towards the connection region 16 upon separating the contacts as shown. Meanwhile, the circumferential gap 14 that follows the position of the first contact section 21 starts to get close to the recess opening 28 (FIG. 1A-B) and finally covers the recess opening 28 (FIG. 1C-D). Insulating gas coming from the opening 48 may not only leave through the opening 52 but also enter the circumferential gap 14 and passing the guiding and/or sealing means 62. The particularly hot gas to enter the circumferential gap 14 may be slowed down in the vicinity of the recess 26 in order to drop particles carried thereby.

Here, the at least one recess can be covered and thereby be substantially closed by means of the first contact section 21 particularly when the contacts 12, 20 are separated as shown in FIG. 1C-D (and in FIG. 3). Then, insulating gas may pass the recess 26 and may slow down in the direct vicinity thereof to drop particles.

The length of the first contact 20 and/or the first contact section 21 forming the circumferential gap 14 is designed in a way that in at least one position at contact separation, it closes/covers the recess 26 with an axial overlap on both axial sides of the at least one recess, the axial overlap on both axial sides being selected to be at least 5 mm or more as seen in FIG. 1C-D.

In this embodiment, the recess opening 28 has an axially extending protrusion 30 particularly to constrict the access to the at least one recess 26. The protrusion 30 is formed to partially shape the guiding passage 24, particularly the inner wall 38. The protrusion 30 faces/points towards the connection region 16. At the free end, the protrusion 30 is tapered.

The first contact 20 is in contact to the inner wall 38 by means of an annular guiding and/or sealing means 62 which guides the first contact 20 radially, where this primarily serves to guide the first contact mechanically. The guiding and/or sealing means 62 may be in the shape of a low friction material, e.g., graphite, PTFE or the like.

The first contact 20 is guided and is movable only along the switching axis 18 when in the closed position, the open position and therebetween. Particularly, any radial movement of the first contact 20 is substantially avoided by means of the design.

The recess 26 has along the switching axis 18 an extension 34 that is larger than the extension 36 thereof oblique to the switching axis 18 and/or in radial direction.

In FIG. 2A-B another embodiment is shown which at least substantially corresponds to the embodiment of FIG. 1A-D, wherein however the first contact housing 22 is not in contact to the first contact 20 in any position to realize a contactless sealing. In FIG. 2A the circuit-breaker is in a closed position. In FIG. 2B it is in an open position where a pull rod of the first contact 20 at the end 68 has been pulled out along the switching axis 18.

Here, the first contact 20 has a lever mechanism that is further motion-coupled to the gas moving device 40 with a cylinder 42 to vary a cylinder volume 46 to move gas and a piston 44 shown in part.

The circumferential gap 14 is formed between the substantially cylindrical first contact section 21 of the first contact 20 and the first contact housing 22. It may also be understood that the circumferential gap forms over the entire axial length of the first contact housing 22 with the first contact 20. However, at the first contact section 21 the circumferential gap 14 is particularly radially constricted relative to the two axially adjacent sides at the first contact section 21.

Particularly, the inner wall 38 is substantially cylindrical to form an annular circumferential gap 14 with the first contact 20 and/or the first contact section 21.

The first contact 20 does not touch the first contact housing 22. The first contact housing 22 has five of the recesses 26 arranged axially adjacent to one another. The recesses 26 have an annular shape and serve to trap particles from the insulating gas.

When the circuit-breaker is being opened, particularly hot insulating gas may flow though the circumferential gap 14 and pass the plurality of recesses 26, each of which may continuously catch insulating particles during turbulences of the gas flow. As such, the amount of particles to enter the exhaust 54 can be reduced significantly.

As shown in detail in FIG. 3, the recesses may have a rounded bottom. Particularly, the axial extension 32 of the recess opening 28 is the same as the axial extension 34 of the recess.

Particularly the radial extension 36 of the recess 26 is larger than the axial extensions 32, 34. In other words, the recess 36 may be shaped as a deep recess 36.

As differences of the embodiment of FIG. 2-3 to the embodiment of FIG. 1A-D, no guiding and/or sealing means are provided in the vicinity of the circumferential gap and/or at the recesses 26. The first contact 20 in the section being guided in the first contact housing 22 to form the circumferential gap 14 also has no opening for insulating gas, despite being hollow. Further, the extension 32 of the recess opening 28 along the switching axis 18 is of the same size relative to the extension 34 of the recess 26 along the switching axis 22. There is no protrusion 30 at the recess 26 or the recess opening 28.

It is noted that aspects of the above described and shown embodiments may be combined.

### Reference Signs List

10 making and breaking unit
12 second contact
14 circumferential gap
16 connection region
18 switching axis
20 first contact
21 first contact section
22 first contact housing
24 guiding passage
26 recess
28 recess opening
30 protrusion
32 extension of the recess opening
34 extension of the recess
36 extension of the recess
38 inner wall of the guiding passage
40 gas moving device
42 cylinder
44 piston
46 cylinder volume
48 opening of the first contact
50 chamber
52 opening of the first contact housing
54 exhaust
60 volume
62 guiding and/or sealing means
64 guiding and/or sealing means
66 guiding and/or sealing means
68 end

1-14. (canceled)

15. A circuit-breaker for high-voltage applications comprising:
at least one making and breaking unit having a hollow first contact and a second contact in the shape of a pin to be plugged into the first contact for forming an electrically conductive connection in a connection region, wherein at least one of the contacts is movable along an axially extending switching axis of the circuit-breaker between a closed position where the electrically conductive connection is formed and an open position where the electrically conductive connection is separated; and
a first contact housing having a guiding passage surrounding and forming with the first contact a circumferential gap, which first contact housing has at least one recess surrounding the first contact, which at least one recess is open towards the first contact by means of a recess opening facing the first contact for trapping particles carried by an insulating gas coming from the connection region and passing the circumferential gap; wherein
an extension of the recess opening is shorter than an extension of the at least one recess and/or two or more of said at least one recesses are arranged axially adjacent to one another; and
the first contact and the first contact housing are movable relative to one another in order to in the open position radially substantially close the recess opening and form the circumferential gap on both sides axially adjacent to the recess opening.

16. Circuit-breaker according to claim 15, wherein the circumferential gap forms a passage for the insulating gas between the connection region and an exhaust of the circuit-breaker.

17. Circuit-breaker according to claim 15, having a gas moving device that is built to move the insulating gas at least at the connection region and towards the circumferential gap.

18. Circuit-breaker according to claim 17, wherein the gas moving device comprises a cylinder with a piston movable therein along the switching axis, which piston is motion-coupled to the first contact housing and/or the first contact in order to vary a cylinder volume as a function of the position of the piston in the cylinder.

19. The circuit-breaker according to claim 18, wherein the recess opening and/or the at least one recess at least substantially has/have an annular shape.

20. The circuit-breaker according to claim 15, wherein the recess opening has an axially extending protrusion in order to constrict the access to the at least one recess.

21. The circuit-breaker according to claim 15, wherein the axially extending protrusion is formed to at least partially shape the guiding passage.

22. The circuit-breaker according to claim 15, wherein the axially extending protrusion faces and/or points towards the connection region.

23. Circuit-breaker according to claim 15, wherein the first contact is in contact to an inner wall of guiding passage to guide the first contact and/or to substantially seal the circumferential gap to the insulating gas.

24. The circuit-breaker according to claim 15, wherein the first contact is guided to at least substantially be movable only along the switching axis at least when in the closed position, in the open position and/or in between the closed and open positions.

25. The circuit-breaker according to claim 15, wherein the extension of the at least one recess along the switching axis is larger than the extension of the at least one recess oblique to the switching axis.

26. The circuit-breaker according to claim 15, wherein the extension of the at least one recess along the switching axis is smaller than an extension of the at least one recess oblique to the switching axis.

27. The circuit-breaker according to claim 15, wherein three or more of the at least one recesses are arranged axially adjacent to one another.

28. The circuit-breaker according to claim 15, wherein the first contact has at least one opening for the insulating gas.
